(19) United States
(12) Patent Application Publication
(10) Pub. No.: US 2024/0156116 A1
(43) Pub. Date: May 16, 2024

(54) Cold Smoke Generator

(71) Applicant: Outdoorchef AG, Zurich (CH)

(72) Inventors: Manuel Schob, Zurich (CH); Stephan Pfeifer, Koblenz (CH)

(73) Assignee: Outdoorchef AG, Zurich (CH)

(21) Appl. No.: 18/388,582

(22) Filed: Nov. 10, 2023

(30) Foreign Application Priority Data
Nov. 10, 2022 (CH) 001344/2022

(51) Int. Cl. A23B 4/052; A47J 37/07

(52) U.S. Cl. CPC A23B 4/052; A47J 37/0786

(57) ABSTRACT

A cold smoke generator, also referred to as smoker, in particular for smoking foods like meat, fish, vegetables, etc., can be operated individually or in conjunction with a grill, in particular for use outdoors and indoors. The cold smoke generator includes a metal tube with a combustion chamber, an air supply, and an outlet for smoke. The metal tube is arranged in a stand in a lockable manner.

### FIELD OF THE INVENTION

The invention relates to a cold smoke generator, also referred to as smoker, in particular for smoking foods like meat, fish, vegetables, etc., which can be operated individually or in conjunction with a grill, a smoking chamber, smoking bell, etc., and in particular for use outdoors and indoors.

### BACKGROUND

DE 102018213583 A1 discloses a grill that can be operated as a smoker. It comprises a housing in the form of a commercially available gas bottle, with a combustion chamber and grate. For opening purposes, the housing is divided into a lower housing part with a combustion chamber function and an upper housing part with a cover function.

For example, the smoker can also be used in a grill without gas, in which the smoke is blown into the chamber, and an external heat source is used (candle, liquid from a Raclette oven), for example. Use in an electric grill is likewise possible.

Further known are tubular smokers with an internal combustion chamber for wood chips, which require an external air supply, are complicated and rather inflexible in use, and not stable or safe. There therefore exists a need for an improved cold smoke generator.

### SUMMARY OF THE INVENTION

One aspect of the invention relates to a cold smoke generator, also referred to as smoker, which is suitable in particular for smoking foods like meat, fish, vegetables, etc., and can be safely and very easily operated individually or in conjunction with a grill, in particular used outdoors and indoors. It is further intended to allow indirect grilling in smoke, and economize on energy.

According to the invention, a cold smoke generator comprises a metal tube, for example a steel tube, stainless steel tube or aluminum tube, with a combustion chamber, an air supply, and an outlet for smoke, wherein the steel tube is arranged so that it can be locked in a stand.

Preferable embodiments are disclosed herein.

A pump, an energy source for the latter, and a regulator for setting the pump are advantageously arranged in the stand. In particular, the energy source is a rechargeable battery or battery pack, which allows operation independently of the network.

Further provided is an adapter for connecting the steel tube and stand.

A nozzle, preferably a Venturi nozzle for generating an air flow, is connected to the pump, wherein the Venturi nozzle is advantageously arranged in the adapter, in particular in the direction of the longitudinal axis of the steel tube.

A sheet for placement of wood chips and other material to be burned is advantageously arranged in the metal tube, in particular perpendicular to the longitudinal axis of the metal tube.

The cold smoke generator can be coupled with a grill of a smoker chamber, smoker bell, cold smoke generator pistol, and so on.

Cold smoking can take place using an external heat source independently of gas, current, etc., and makes it possible to grill, smoke, bake, cook, etc., foods with little effort.

The cold smoke generator is an optimal product for classical BBQ (low & slow, like pulled pork, brisket, ribs), without having to purchase an expensive grill.

### BRIEF DESCRIPTION OF THE DRAWINGS

The invention will be described in more detail below in an exemplary embodiment based upon a drawing. The drawings show:

FIG. 1: a cold smoke generator according to the invention;

FIG. 2: a detailed view (partial section) of the cold smoke generator according to FIG. 1,

FIG. 3: another detailed view of the cold smoke generator according to FIG. 1;

FIG. 4: another detailed view of the cold smoke generator according to FIG. 3;

FIG. 5: another detailed view of the cold smoke generator according to FIG. 1;

FIG. 6: accessories for the cold smoke generator according to FIG. 1, and

FIG. 7: a cold smoke generator according to FIG. 1 in conjunction with a grill.

### DETAILED DESCRIPTION

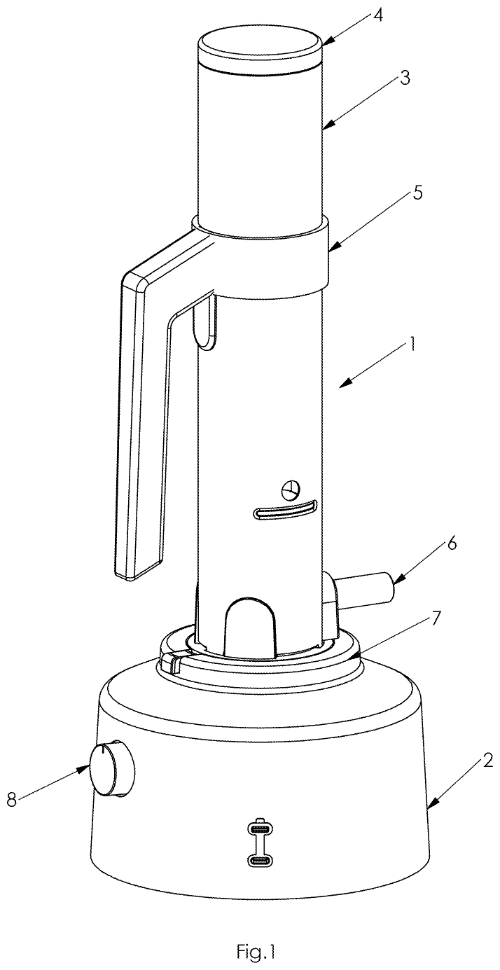

In the example, a cold smoke generator 1 according to the invention, also referred to as smoker, comprises a stainless steel tube 3, which is arranged upright in a stand 2 (FIG. 1). An upper front side of the stainless steel tube is sealed with a removable cover 4.

Also arranged on the stainless steel tube 3 is a grip 5, which enables a safe handling of the cold smoke generator 1. A combustion chamber 10, in particular for wood chips, pellets, etc., is provided in the stainless steel tube 3, spaced apart from its wall.

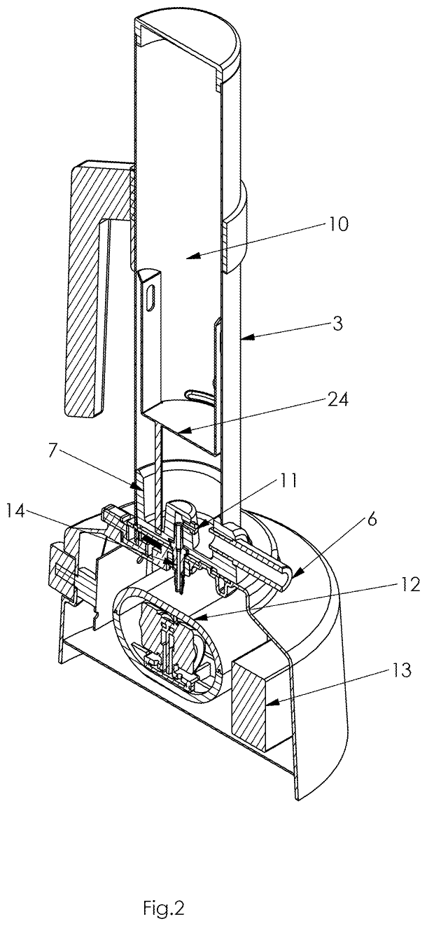

A sheet 24 as an intermediate sheet for the placement of wood chips and the like to be burned is arranged in the stainless steel tube 3, in the example perpendicular to the longitudinal axis of the stainless steel tube 3 (FIG. 2). The wood chips can slowly burn off and generate smoke on the sheet 24. Located above the sheet 24 are openings in the wall of the stainless steel tube 3 (FIG. 2), through which the wood chips can be kindled.

The sheet 24 divides the interior of the stainless steel tube 3 into a combustion chamber above the sheet 24 and a low-pressure chamber below the latter.

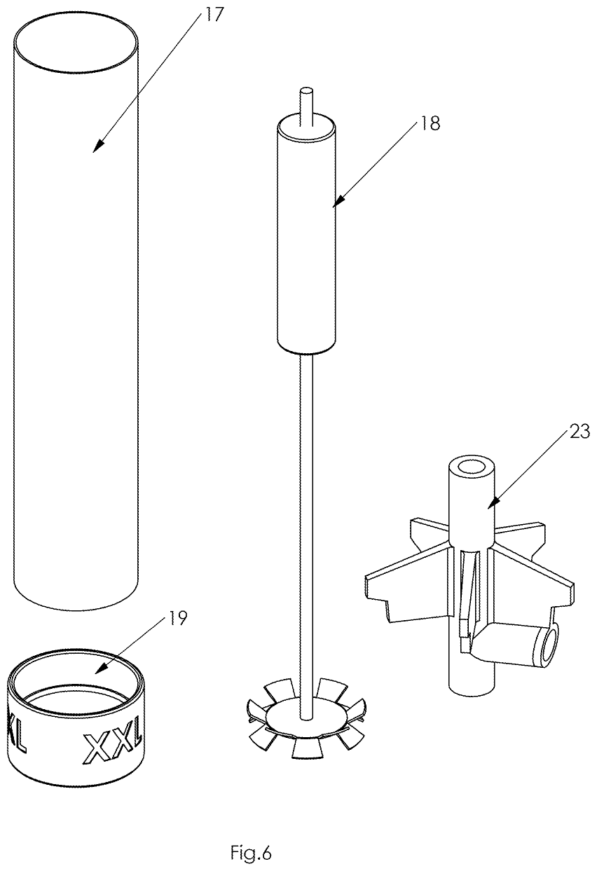

If needed, once the cover 4 has been removed, an extension tube 17 can be placed on the stainless steel tube by means of an intermediate piece 19 (FIG. 6). In addition, an outlet tube 6 for the smoke generated during the operation of the cold smoke generator 1 passes through the wall of the stainless steel tube 3.

A pump 12 for generating an air flow and a rechargeable battery 13 or battery pack for supplying energy to the pump 12 are integrated into the stand 2. The rechargeable battery can be charged with a charging cable, directly at the grill or point of use, or the stainless steel tube 3 is separated from the stand 2 so as to be charged at another location.

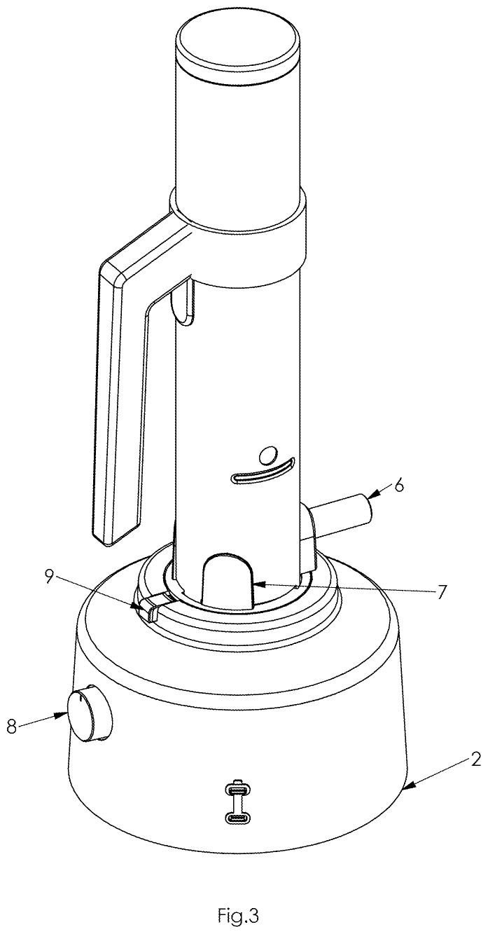

The connection between the stainless steel tube 3 and stand is established by an adapter, specifically a silicone adapter 7 with integrated Venturi nozzle 11 in the example (FIG. 2). A click switch 9 (FIG. 3) can be used to lock the stainless steel tube 3 in the stand or detach it from the latter.

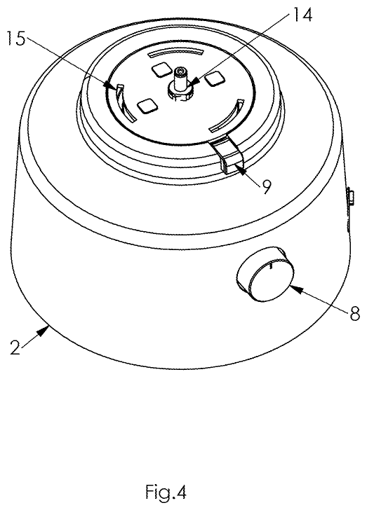

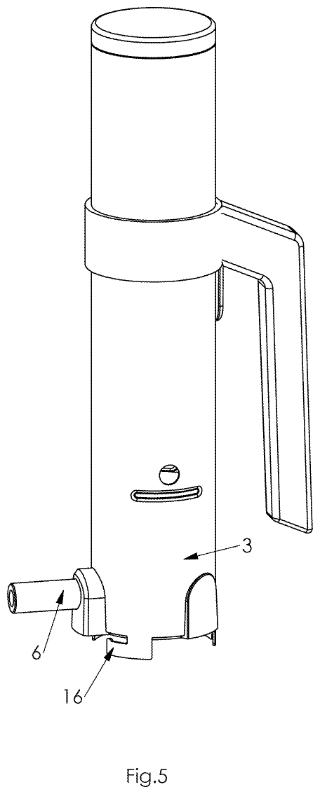

For locking purposes, the example provides that extensions 16 (FIG. 5) of the stainless steel tube 3 be inserted into slots 15, three each (FIG. 4) in the example, of the silicone adapter 7, and turned until a bayonet-type recess of the extensions 16 latches.

The Venturi nozzle 11 is arranged in the direction of the longitudinal axis of the stainless steel tube 3, and has a connection 14 to the pump 12 not shown in all of its detail. During operation of the pump 12, an air flow directed toward the combustion chamber 10 is generated in the Venturi nozzle 11. The power of the pump 12, and hence the strength of the air flow (or intensity of the smoke) can be adjusted by means of a regulator 8 (FIG. 1, 2) in the stand 2.

The cold smoke generator 1 can be operated independently of other equipment or in conjunction with a grill.

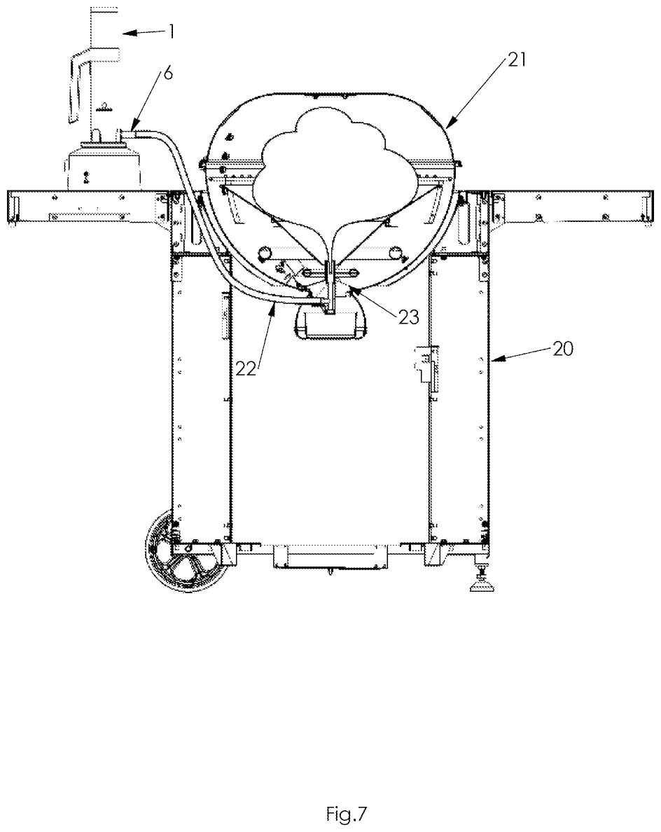

During operation with a grill, a gas grill 20 in the exemplary embodiment (FIG. 7), for example a gas grill according to CH 781524 A, there is a spherical grilling chamber 21 in which a burner assembly (not shown) is arranged.

Generated smoke is guided into the grilling chamber 21 by means of a silicone hose 22, one end of which is slipped over the outlet tube 6 (FIG. 7), so that the smoke can circulate in the latter, and smoke foods deposited there. A hose holder 23 can be used to fix the silicone hose 22 to the grilling chamber 21.

The smoker can also be used in any other kind of grill desired. The feeder of the hose 22 is here always directly connected to the respective grilling chamber. In normal rectangular grills, this usually takes place through the opening of the rotisserie kit.

A cleaning brush 18 can be used to clean the stainless steel tube 3 and combustion chamber 10.

The cold smoke generator 1 can be operated independently of a network connection or independently of an external power supply.

### REFERENCE LIST

1 Cold smoke generator
2 Stand
3 Stainless steel tube
4 Cover
5 Grip
6 Outlet tube
7 Silicone adapter
8 Regulator
9 Click switch
10 Combustion chamber
11 Venturi nozzle
12 Pump
13 Rechargeable battery
14 Connection
15 Slot
16 Extension
17 Extension tube
18 Cleaning brush
19 Intermediate piece
20 Gas grill
21 Grilling chamber
22 Silicone hose
23 Hose holder
24 Sheet

1. A cold smoke generator comprising a metal tube with a combustion chamber, an air supply and an outlet for the smoke, wherein the metal tube is arranged in a stand in a lockable manner.

2. The cold smoke generator according to claim 1, wherein a pump, an energy source for the pump, and a regulator for adjusting the pump are arranged in the stand.

3. The cold smoke generator according to claim 1, wherein a nozzle for generating an air flow is connected to the pump.

4. The cold smoke generator according to claim 3, wherein the nozzle is a Venturi nozzle.

5. The cold smoke generator according to claim 1, wherein the cold smoke generator is connectable to a grill.

6. The cold smoke generator according to claim 1, wherein an adapter is arranged for connecting the metal tube and the stand.

7. The cold smoke generator according to claim 6, wherein a Venturi nozzle for generating an air flow is connected to the pump and wherein the Venturi nozzle is arranged in the adapter.

8. The cold smoke generator according to claim 1, wherein a sheet is arranged in the metal tube.

9. The cold smoke generator according to claim 8, wherein the sheet is arranged perpendicular to the longitudinal axis of the metal tube.

10. The cold smoke generator according to claim 1, wherein the metal tube is a stainless steel tube or an aluminum tube.
